(19) United States
(12) Patent Application Publication
(10) Pub. No.: US 2009/0122029 A1
(43) Pub. Date: May 14, 2009

(54) Stylus pen

(75) Inventor: Ki Sub Sin, Seoul (KR)

Correspondence Address: LADAS & PARRY LLP, 26 WEST 61ST STREET, NEW YORK, NY, 10023, US

(73) Assignee: NEWVIT CO. LTD.

(21) Appl. No.: 12/077,677

(22) Filed: Mar. 20, 2008

(30) Foreign Application Priority Data
Nov. 13, 2007 (KR) 20-2007-0018266
Feb. 11, 2008 (KR) 20-2008-0001795

(51) Int. Cl. G06F 3/033

(52) U.S. Cl. 345/179

(57) ABSTRACT

An improved stylus pen is disclosed, which comprises a body; a pen support part which is engaged to an upper side of the body and includes a support body having a holding groove at its one side, and a stopper support part which is spaced apart from an inner wall of the support body and has a stopper engaging groove in its inner surface; and a pen part which passes through the interior of the pen support part and includes a pen body formed at its one side and having a stopper engaged by means of the stopper engaging groove, and a head part which is engaged to an upper side of the pen body and has a tip.

### TECHNICAL FIELD

The present invention relates to a stylus pen, and in particular to a stylus pen used in a portable terminal which can be conveniently attached or detached and feels better in its operation and has a stable support force.

### BACKGROUND ART

Generally, a portable personal information terminals represents all types of portable terminals such as a personal digital assistant (PDA), a next generation mobile communication terminal, a hand-held PC, etc. As the use of such portable terminals increases, they are equipped with various advanced functions. Various advanced functions and compact size and stylus designs help a good sale and business.

Such terminals are being equipped with various advanced functions such as an internet function, a text process function, a graphic process function, etc. basically including an audio and video communication function. In addition to the above advanced functions, a touch screen method or an audio input method, which does not need an additional keypad, has been disclosed for meeting both the demands of advanced functions and compact size features.

Here, a stylus pen is used for operating a touch screen terminal. The stylus pen is made in a common pen shape. It has a tip at its end for inputting and outputting information. This stylus pen is stored in an engaging hole formed at its one side or is carried by a user all the time when the portable terminal is used. So, the volume of the stylus should be substantially small. In addition, it should be provided with a certain size small enough so that a user can easily hold.

The Korean utility model publication number 20-2003-0025185 (Oct. 30, 2003) discloses a multi-step stylus pen. The multi-step stylus pen comprises a head which forms a tip formed at its end for inputting information, a first cylinder engaged to the head, a second cylinder which is extended from or returns into the first cylinder, a first piston which is formed at its one end and is received in the first cylinder, a second piston which is formed at its other end and is received in the second cylinder, and a rod which is extended from or returns into the second cylinder.

The above conventional stylus pen can be made in a small and compact size with its three-step adjustable feature. A non built-in type lid is engaged therein. With the above features, it looks nice, and it is so easy to use. However, the lid should be disadvantageously turned so as to detach the lid from the second cylinder. In order to extend the first cylinder with multiple steps, the head part should be gripped and then pulled out in multiple steps, which leads to many inconveniences when is use. When the first cylinder or a rod is extended in maximum, the extended first cylinder is not supported by means of a certain support member such as a ring or something, so that the extended portions may be disengaged.

### DISCLOSURE OF THE INVENTION

Accordingly, it is an object of the present invention to provide a stylus pen which overcomes the problems encountered in a conventional stylus pen.

It is another object of the present invention to provide a stylus pen which can be conveniently attached or detached and feels better in its operation and has a stable support.

To achieve the above objects, in a stylus pen used in a portable terminal, there is provided an improved stylus pen which comprises a body; a pen support part which is engaged to an upper side of the body and includes a support body having a holding groove at its one side, and a stopper support part which is spaced apart from an inner wall of the support body and has a stopper engaging groove in its inner surface; and a pen part which passes through the interior of the pen support part and includes a pen body formed at its one side and having a stopper engaged by means of the stopper engaging groove, and a head part which is engaged to an upper side of the pen body and has a tip.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a stylus pen according to an embodiment of the present invention;

FIG. 2 is a disassembled perspective view illustrating a stylus pen of FIG. 1;

FIG. 3 is a disassembled cross sectional view illustrating a stylus pen of FIG. 1;

FIG. 4 is a perspective view illustrating an expanded part of a pen part adapted to a stylus pen of FIG. 2;

FIG. 5 is a plane view illustrating a body belonging to a stylus pen of FIG. 2;

FIG. 6 is a perspective view of another example of an expanded part of a pen part adapted to a stylus pen of FIG. 2;

FIGS. 7A through 7D are views illustrating an operation state of a stylus pen of FIG. 1;

FIG. 8 is a view of another example of a tip belonging to a stylus pen of FIG. 2; and

FIG. 9 is a view illustrating a use state of a stylus pen which adapts another example of a pen of FIG. 8.

### MODES FOR CARRYING OUT THE INVENTION

The preferred embodiments of the stylus pen according to the present invention will be described with reference to the accompanying drawings.

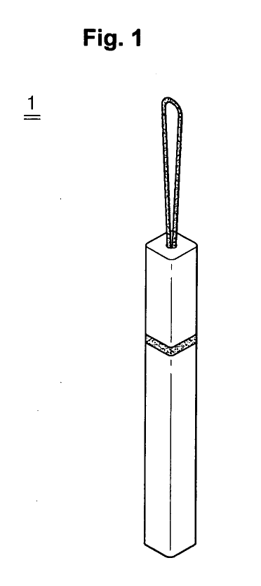

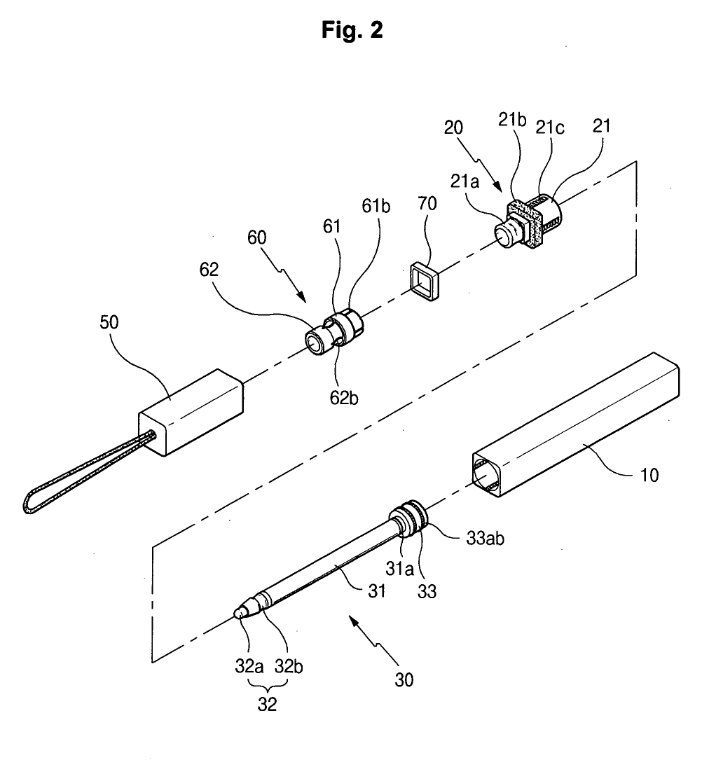

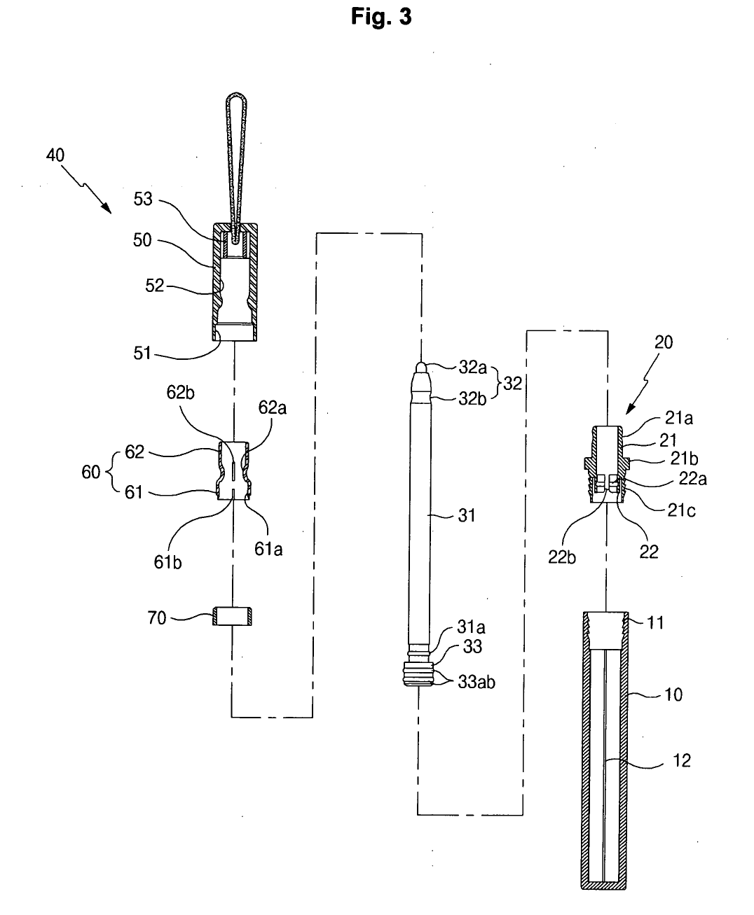

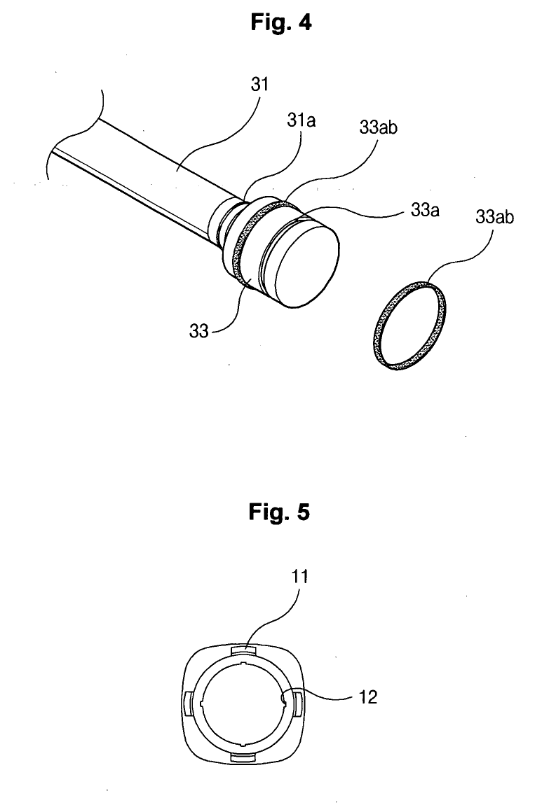

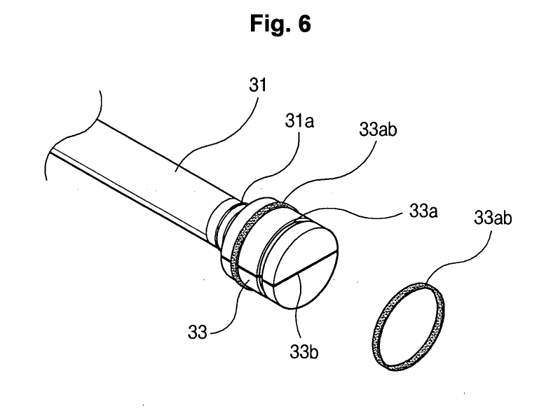

FIG. 1 is a perspective view illustrating a stylus pen according to an embodiment of the present invention, FIG. 2 is a disassembled perspective view illustrating a stylus pen of FIG. 1, FIG. 3 is a disassembled cross sectional view illustrating a stylus pen of FIG. 1, FIG. 4 is a perspective view illustrating an expanded part of a pen part adapted to a stylus pen of FIG. 2, FIG. 5 is a plane view illustrating a body belonging to a stylus pen of FIG. 2, and FIG. 6 is a perspective view of another example of an expanded part of a pen part adapted to a stylus pen of FIG. 2.

As shown therein, the stylus pen according to a preferred embodiment of the present invention comprises a body 10, a pen support part 20, a pen part 30 and a cap 40.

The body 10 is engaged to a lower side of a rim part 21b of the pen support part 20. As shown in FIG. 2, the body 10 is rectangular-cubic and is empty so that the pen part 30 can move therein. As shown in FIG. 3, a hook fixing groove 11 is formed on an upper side of the body 10 with a hook protrusion 21c of the pen support part 20 being fixed in the hook fixing groove 11. A rail groove 12 is formed in a portion spaced apart from the hook fixing groove 11 and is longitudinally extended up to the bottom of the body 10.

The rail groove 12 has an air flow passage function, so that compressed air can be discharged when the pen part 30 is inserted into the body 10. Preferably, as shown in FIG. 5, four rail grooves 12 are formed at angles of 90°.

The rail groove 12 provides a proper damping force into the interior of the body 10, so that air can smoothly communicate through the rail grove 12 when the pen 30 is extended from or returns. Consequently, a sliding operation feels so good when the pen part 30 reciprocates. The complicated processes for cutting out the lower side of the pen support part 20 for air communication are not needed, which leads to a lower process cost.

The pen support part 20 is empty, so the pen part 30 can move therein. As shown in FIG. 2, the pen support part 22 comprises a support body 21 having a holding groove 21a formed on its upper outer side, a rim part 21b formed on its center portion, and a hook protrusion 21c formed on its lower side, and a stopper support part 22 which is spaced apart from a lower inner wall of the support body 21 as shown in FIG. 3 and has a stopper engaging groove 22a formed in an inner wall.

The pen support part 20 is inserted into the hook fixing groove 11 of the body 10 by means of the hook protrusion 21c formed on its lower side, so the assembling process can be more simplified, and the engaged structure can be strengthened.

The holding groove 21a enables the holding groove holding part 61 of the cap 40 to be stably fixed, and the rim part 21b enables the support body 21 to be divided and separately stored in the body 10 and the cap 40, respectively, so that the pen support part 20 can be stably supported in the body 10.

The stopper support part 22 supports the pen body 31 of the pen part 30 when the pen part 30 moves, and allows the stopper 31a formed in the pen body 31 to be caught and supported by the stopper engaging groove 22a of the stopper support part 22 when the pen part 30 is moved in maximum. At this time, the support part 22 has a cut-off part 22b so that the stopper 31a can have a certain elastic force when it is caught by means of the stopper engaging groove 22a.

The pen part 30 passes through the interior of the pen support part 20 and comprises a pen body 31 having a stopper 31a formed its lower side as shown in FIG. 2, a head part 32 which is tightly inserted into an upper side of the pen body 31 with a tip 32a being formed at its upper side, and with a head groove 32b being formed at its lower side, and an expanded part 33 of which a diameter is expanded at a lower side of the pen body 31 and which has a gasket groove 33a engaged with a rubber gasket 33ab on its outer surface as shown in FIG. 4.

The stopper 31a fixes the pen part 30 to the pen support part 20, and the head groove 32b allows the pen part 30 to be attached or detached along the cap 40. The gasket 33ab engaged to the gasket 33a is closely supported by means of an inner diameter surface of the body 10 and slides.

As shown in FIG. 6, the expanded part 33 is provided with a cut-off groove 33b longitudinally formed in the center portion. The cut-off groove 33b allows compressed air to be discharged when the pen part 30 is inserted into the body 10, so that the pen part 30 can smoothly move. As shown in FIG. 4, the cut-off groove 33b cannot be formed in the expanded part 33 when the rail groove 12 is formed in the body 10.

As shown in FIG. 3, the cap 40 includes a cap body 50 having a ring receiving groove 51 formed in a lower inner wall, and a holding member receiving groove 52 upwardly bent and extended from the ring receiving groove 51, a holding member 60 which is fixed to the holding member receiving groove 52, and a rectangular ring 70 which is tightly inserted into the ring receiving groove 51.

As shown in FIG. 3, a fixing cord support part 53 adapted for fixing a fixing cord is integrally formed with the cap body 50 on an upper side of the holding member receiving groove 52.

The holding member 60 is fixed in the holding member receiving groove 52 near the ring receiving groove 51 as shown in FIG. 3 and comprises a holding groove holding part 61 with a holding groove support protrusion 61a being formed in its inner wall, and with a longitudinal slit 61b being extended from its one end, and a head groove holding part 62 which is integrally extended from one side of the holding groove holding part 61 with a head groove support protrusion 62a being formed on its inner wall, and with a cutting-off groove 62b being extended from its one end to the other end.

When the holding groove holding part 61 and the head groove holding part 62 are integrally formed in the holding member 60, respectively, it is not needed to engage the holding groove holding part 61 and the head groove holding part 62 to the cap 40, respectively. So, an assembling process decreases, and the manufacture does not cost a lot.

The holding groove support protrusion 61a supports the holding groove 21a of the pen support part 20 inserted, and the head groove support protrusion 62a supports the head groove 32b of the pen part 30 inserted. The slit 61b and the cut-off groove 62b are expanded when the front sides of the pen support part 20 and the pen part 30 are inserted, and then are contracted for thereby holding the same, respectively.

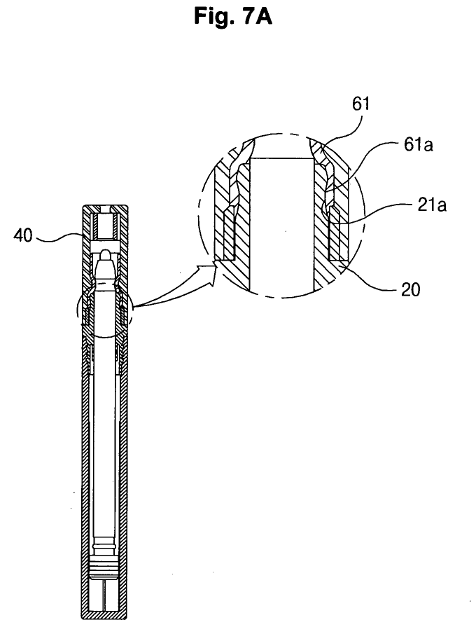

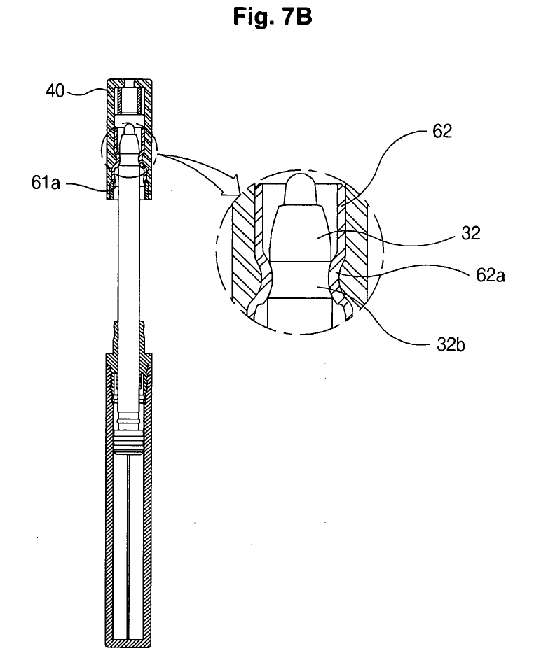

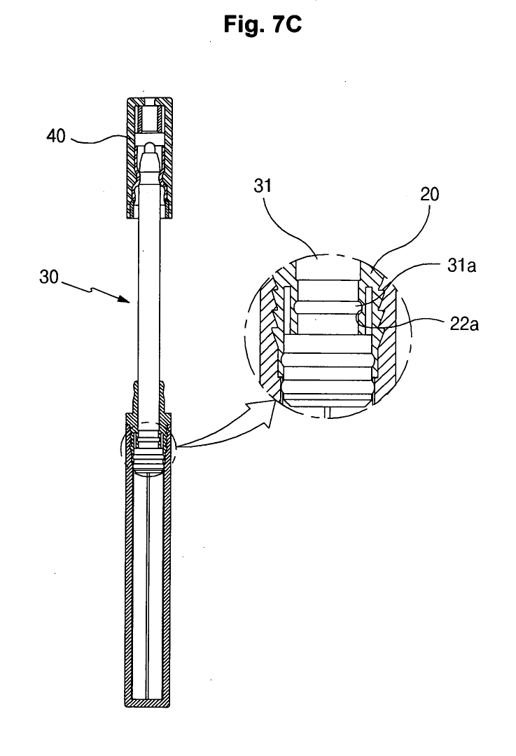

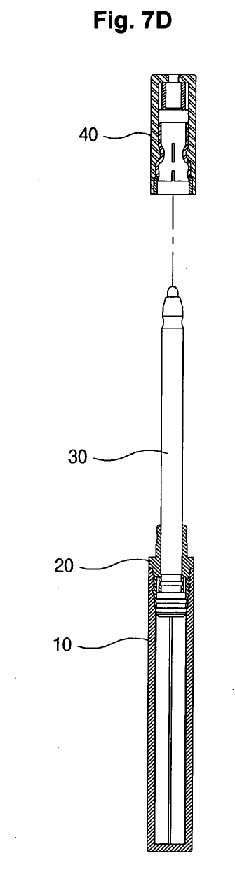

FIGS. 7A through 7D are views of the operation states of the stylus pen of FIG. 1.

As shown in FIG. 7A, in a state that the cap 40 is closed, the cap 40 is caught by the holding groove 21a of the pen support part 20 by means of the holding groove support protrusion 61a of the holding groove holding part 61, so it does not disengaged unless a certain level external force is applied thereto. In this case, when the cap 40 is pulled, as shown in FIG. 7B, the holding groove support protrusion 61a of the holding groove holding part 61 and the holding groove 21a are unlocked, and the pen part 30 is automatically taken out by means of the cap 40.

As shown in FIG. 7B, the head groove support protrusion 62a of the head groove holding part 62 is caught by means of the head groove 32b of the head part 32. Here, the head groove support protrusion 62a may be preferably further protruded for having a stronger support force than the holding groove support protrusion 61a.

As shown in FIG. 7C, when the cap 40 is continuously pulled, the pen part 30 is caught by means of the pen support part 20 because the stopper 31a formed in the pen part 30 is caught by means of the stopper engaging groove 22a formed in the pen support part 20 and is supported by the same, so the pen body 31 is supported by means of an inner wall of the pen support part 20.

As shown in FIG. 7D, in a state that the pen part 30 is supported by means of the pen support part 20, when the cap 40 is further pulled, the cap 40 is separated. When it is needed to engage the cap 40, the procedure reverse to the above sequence is performed. While the above example is provided only the illustrative purpose, another examples can be applied, namely, it can be performed in a state that the pen part 30 is not separated to the outside.

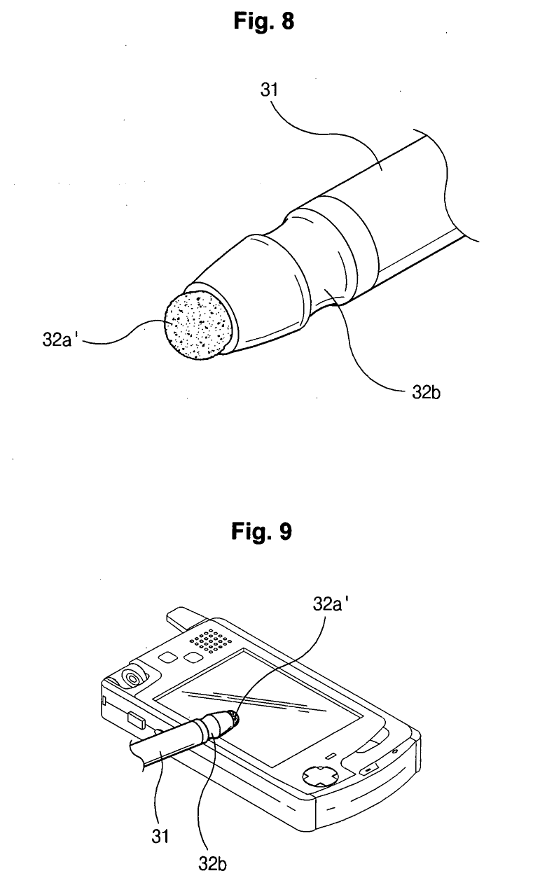

FIG. 8 is a view of another example of a tip belonging to a stylus pen of FIG. 2, and FIG. 9 is a view illustrating a use state of a stylus pen which adapts another example of a pen of FIG. 8.

As shown in FIG. 8, the tip 32a formed in the head part 32 of the pen part 30 may be substituted with an electrostatic capacitance type tip 32a′. In the electrostatic capacitance type, a desired function can be activated as a small current flowing in a human body such as a finger or something unless a corresponding button is pushed. The processes that the change of a signal is recognized by means of a controller, and a screen is switched are the same as a resistance pressure method.

The tip 32a′ is preferably made in such a manner that a certain material having a lot of carbon is mixed with a sponge, a rubber plate, an EVA (Ethylene Vinyl Acetate) or something and then is molded. When the above electrostatic capacitance type is used, it is possible to prevent a certain scratch or stain can be prevented.

As described above, the stylus pen according to the present invention has the following advantages.

First, when a pen part is extended in maximum, a stopper provided in the pen part is stably fixed by means of a stopper engaging groove of a pen support part, which leads to an enhanced support force.

Second, it should be appreciated that a holding groove holding part having a holding groove support protrusion is engaged in the interior of a cap, so the cap can be easily disengaged from the pen part.

Third, a pen part can be automatically pulled out with the helps of a head groove formed in a head part and a head groove holding part engaged in the interior of the cap and having a head groove support protrusion when the cap is disengaged, so it is not needed to pull out the pen part in the present invention.

Fourth, since a hook protrusion formed in a pen support part is engaged to a hook fixing groove of a body, so that an assembling process can be simplified, and an engaging force can be surely enhanced.

Fifth, compressed air is discharged through an air flow groove formed in a body, so that a pen part can be easily moved.

Sixth, a pen support part can be stably supported in a body by means of a rim part formed in the pen support part.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a stylus pen used in a portable terminal, an improved stylus pen, comprising:
a body;
a pen support part which is engaged to an upper side of the body and includes a support body having a holding groove at its one side, and a stopper support part which is spaced apart from an inner wall of the support body and has a stopper engaging groove in its inner surface; and
a pen part which passes through the interior of the pen support part and includes a pen body formed at its one side and having a stopper engaged by means of the stopper engaging groove, and a head part which is engaged to an upper side of the pen body and has a tip.

2. The pen of claim 1, further comprising a cap in which a holding groove holding part is engaged in its interior, with the holding groove holding part being provided with a holding support protrusion in an inner wall for an attachment and detachment from the pen support part.

3. The pen of claim 2, wherein a head groove is formed at one side of the head part, and a head engaging part, which has a head groove support protrusion integrally extended from one side of the holding groove holding part and which has a head groove support protrusion in its inner wall, is engaged in the interior of the cap, so that when the cap is disengaged from the pen support part, the pen part is disengaged along with the cap.

4. The pen of claim 3, wherein an expanded part engaged with a gasket is formed at one end of the pen body of the pen part.

5. The pen of claim 4, wherein a cut-off part having a certain elastic force is formed in the stopper support part.

6. The pen of claim 5, wherein a hook fixing groove is formed in an upper side of the body, and a hook protrusion is formed in the support body of the pen support part, and the pen support part is inserted into the body.

7. The pen of claim 6, wherein a rail groove acting as an air flow passage is formed in an inner wall of the body.

8. The pen of claim 6, wherein a cut-off groove is formed in the expanded part for allowing air to flow along the same.

9. The pen of claim 7, wherein a rim part is formed in one side of the support body of the pen support part, and a lower side of the rim part is accommodated in the body, and its upper side is accommodated in the cap, respectively.

10. The pen of claim 8, wherein a rim part is formed in one side of the support body of the pen support part, and a lower side of the rim part is accommodated in the body, and its upper side is accommodated in the cap, respectively.
